(19) United States
(12) Patent Application Publication
(10) Pub. No.: US 2025/0247727 A1
(43) Pub. Date: Jul. 31, 2025

(54) COMMUNICATION METHOD AND COMMUNICATION APPARATUS FOR USE IN SENSING MEASUREMENT SETUP TERMINATION

(71) Applicant: Beijing Xiaomi Mobile Software Co., Ltd., Beijing (CN)

(72) Inventor: Xiandong DONG, Beijing (CN)

(21) Appl. No.: 18/855,513

(22) PCT Filed: Apr. 14, 2022
(86) PCT No.: PCT/CN2022/086918

§ 371 Date: Oct. 9, 2024

(51) Int. Cl. H04W 24/10; H04B 7/06; H04W 84/12

(52) U.S. Cl. CPC H04W 24/10; H04B 7/0626; H04W 84/12

(57) ABSTRACT

A communication method for sensing measurement setup termination, includes: determining a sensing measurement setup termination message frame, wherein the sensing measurement setup termination message frame includes information of at least one sensing measurement procedure to be terminated, wherein the at least one sensing measurement procedure corresponds to at least one sensing measurement setup identifier; and sending the sensing measurement setup termination message frame.

### CROSS-REFERENCE TO RELATED APPLICATION

The application is a U.S. National Stage of International Application No. PCT/CN2022/086918 filed on Apr. 14, 2022, the entire content of which is incorporated herein by reference.

### TECHNICAL FIELD

The present disclosure relates to the field of wireless communications, and more specifically, to a communication method and communication apparatus for sensing measurement setup termination.

### BACKGROUND

Wireless Local Area Network (WLAN) has the characteristics of flexibility, mobility and low cost. With the development of communication technology and the growth of user needs, the research on WLAN applications is gradually deepening. For example, WLAN sensing is currently being researched. Its main application scenarios are: location discovery in dense environments (home environment and enterprise environment), proximity detection, presence detection, etc.

### SUMMARY

Various embodiments of the present disclosure provide the following technical solutions.

According to an example embodiment of the present disclosure, there is provided a communication method for sensing measurement setup termination. The communication method may include: determining a sensing measurement setup termination message frame, where the sensing measurement setup termination message frame includes information of at least one sensing measurement procedure to be terminated, where the at least one sensing measurement procedure corresponds to at least one sensing measurement setup identifier; and sending the sensing measurement setup termination message frame.

According to an example embodiment of the present disclosure, there is provided a communication method for sensing measurement setup termination. The communication method may include: receiving a sensing measurement setup termination message frame, where the sensing measurement setup termination message frame includes information of at least one sensing measurement procedure to be terminated, where the at least one sensing measurement procedure corresponds to at least one sensing measurement setup identifier; and terminating the at least one sensing measurement procedure according to the sensing measurement setup termination message frame.

According to an example embodiment of the present disclosure, there is provided a communication apparatus. The communication apparatus may include: a processing module configured to: determine a sensing measurement setup termination message frame, where the sensing measurement setup termination message frame includes information of at least one sensing measurement procedure to be terminated, where the at least one sensing measurement procedure corresponds to at least one sensing measurement setup identifier; and a transceiver module, configured to: send the sensing measurement setup termination message frame.

According to an example embodiment of the present disclosure, there is provided a communication apparatus. The communication apparatus may include: a transceiver module, configured to: receive a sensing measurement setup termination message frame, where the sensing measurement setup termination message frame includes information of at least one sensing measurement procedure to be terminated, where the at least one sensing measurement procedure corresponds to at least one sensing measurement setup identifier; and a processing module, configured to: terminate the at least one sensing measurement procedure according to the sensing measurement setup termination message frame.

According to an example embodiment of the present disclosure, there is provided an electronic apparatus. The electronic apparatus includes a memory, a processor, and a computer program stored on the memory and executable by the processor. The processor implements the methods as described above when executing the computer program.

According to an example embodiment of the present disclosure, there is provided a computer-readable storage medium. A computer program is stored on the computer-readable storage medium. The computer program, when executed by a processor, implements the methods described above.

The technical solutions provided by the example embodiments of the present disclosure clearly define the sensing measurement setup termination message frame to improve the mechanism of sensing measurement setup termination.

### BRIEF DESCRIPTION OF THE DRAWINGS

The above and other features of the embodiments of the present disclosure will be more apparent by describing in detail the example embodiments of the present disclosure with reference to the accompanying drawings, in which:

FIG. 1 is an exemplary manner illustrating WLAN sensing according to an example embodiment.

FIG. 2 is a flowchart illustrating a communication method according to an example embodiment.

FIG. 3 is a flowchart illustrating another communication method according to an example embodiment.

FIG. 4 is a block diagram illustrating a communication apparatus according to an example embodiment.

### DETAILED DESCRIPTION

The following description with reference to the accompanying drawings is provided to assist in a comprehensive understanding of various embodiments of the present disclosure as defined by the appended claims and their equivalents. Various embodiments of the present disclosure include various specific details, but these specific details are considered to be exemplary only. Additionally, descriptions of well-known techniques, functions, and constructions may be omitted for the sake of clarity and conciseness.

The terms and words used in the present disclosure are not limited to the written meanings, but, are merely used by the inventor to enable a clear and consistent understanding of the present disclosure. Accordingly, for those skilled in the art, the description of the various embodiments of the present disclosure is provided for illustration purpose only and not for purpose of limitation.

It should be understood that, as used herein, the singular forms “a/an,” “one,” “said” and “the” may include the plural forms as well, unless the context clearly dictates otherwise. It should be further understood that the word “include” as used in the present disclosure refers to the presence of the described features, integers, steps, operations, elements and/or components, but does not exclude the presence or addition of one or more other features, integers, steps, operations, elements, components and/or groups thereof.

It will be understood that, although the terms “first,” “second,” etc. may be used herein to describe various elements, these elements should not be limited by these terms. These terms are only used to distinguish one element from another. Accordingly, a first element discussed below may be referred to as a second element without departing from the teachings of example embodiments.

It should be understood that when an element is referred to as being “connected” or “coupled” to another element, it can be directly connected or coupled to the other element or an intervening element may also be present. Additionally, “connected” or “coupled” as used herein may include wireless connections or wireless couplings. As used herein, the term “and/or” or the expression “at least one/at least one of” includes any and all combinations of one or more of the associated listed items.

Unless otherwise defined, all terms (including technical and scientific terms) used herein have the same meaning as commonly understood by one of ordinary skill in the art to which the present disclosure belongs.

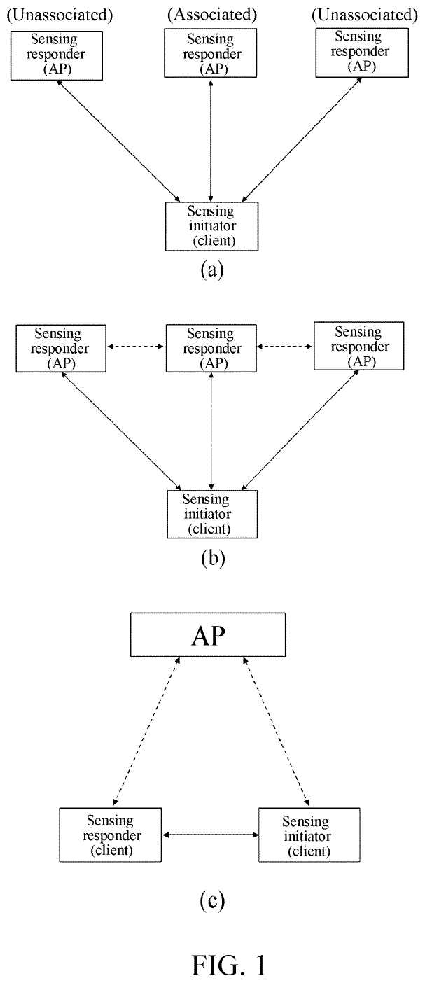

FIG. 1 is an exemplary manner illustrating WLAN sensing.

The process of WLAN sensing may be as follows: the initiator initiates WLAN sensing (for example, initiates a WLAN sensing session), and there may be multiple responders responding to it. The specific possible manners may be as shown in (a), (b) and (c) in FIG. 1.

Referring to (a) in FIG. 1, when a WLAN sensing initiator (e.g., a client) initiates WLAN sensing, multiple associated or unassociated WLAN sensing responders (e.g., three access points (APs)) can respond. “Associated” here may mean that an associated connection for communication has been established between the initiator and the responder, and “unassociated” may mean that no associated connection for communication has been established between the initiator and the responder.

As an example, client may include, but is not limited to: a cellular phone, a smartphone, a wearable device, a computer, a personal digital assistant (PDA), a personal communications system (PCS) device, a personal information manager (PIM), a personal navigation device (PND), a global positioning system, a multimedia device, an Internet of Things (IoT) device, etc.

AP may be a wireless switch used for a wireless network or an access device of a wireless network. AP may include software applications and/or circuits to enable other types of nodes in the wireless network to communicate with the outside and inside of the wireless network through AP. As an example, AP may be a terminal device or a network device equipped with a Wireless Fidelity (Wi-Fi) chip.

(b) in FIG. 1 is similar to (a) in FIG. 1, but in (b) in FIG. 1, communication may be conducted between individual responders (APs).

Referring to (c) in FIG. 1, both the WLAN sensing initiator and the WLAN sensing responder may be clients, and they may communicate by connecting to the same AP.

Although it is shown in (a), (b) and (c) in FIG. 1 that the client serves as the initiator and the AP serves as the responder, the present disclosure is not limited thereto. For example, for ease of explanation, in various embodiments of the present disclosure, the AP may serve as the initiator and the client may serve as the responder. In addition, in various embodiments of the present disclosure, the client may also be called a non-AP station (non-AP STA), referred to as a “station (STA)” for short. Furthermore, the numbers of the initiators and the responders are not limited to those shown in (a), (b) and (c) in FIG. 1.

As an illustrative embodiment, the procedure of WLAN sensing may include: WLAN sensing session setup, WLAN sensing measurement setup, and WLAN sensing measurement termination.

In WLAN sensing session setup, a sensing initiator (e.g., AP) may initiate a WLAN sensing session, a sensing responder (e.g., STA) may respond to it, and an operating parameter(s) associated with the sensing session may be determined and exchanged between devices. In the following, the term “sensing initiator” may be used interchangeably with “initiator”, and the term “sensing responder” may be used interchangeably with “responder”.

One WLAN sensing session setup may contain one or more WLAN sensing measurement setups. That is, one or more WLAN sensing measurements may be set up between the initiator (e.g., AP) and the responder (e.g., STA). For example, each WLAN sensing measurement may utilize a corresponding sensing measurement setup identifier (measurement setup ID, MSID) to identify. The WLAN sensing measurement corresponding to each measurement setup ID may include one or more WLAN sensing measurement events. The sensing measurement may be performed for each WLAN sensing measurement event. In each WLAN sensing measurement event, the sensing measurement may be performed through a sensing measurement frame. For example, in some embodiments, the transmitter that sends the sensing measurement frame may be an AP, and the receiver may be an STA. In this case, the receiver STA may report the sensing measurement result (for example, channel state information (CSI)) to the transmitter AP.

In WLAN sensing measurement termination, the device stops performing measurements and terminates the sensing session. For example, the sensing initiator (or sensing responder) may initiate termination of one or more sensing measurement setups by sending a sensing measurement setup termination message frame to the sensing responder (or sensing initiator). That is, for example, after the initiator receives the sensing measurement result report, the initiator or the responder may initiate a sensing measurement setup termination message frame to the other party, and the sensing measurement setup termination message frame can terminate one or more sensing measurement procedures. However, in the current research, the mechanism for sensing measurement setup termination is not yet complete. For example, the sensing measurement setup termination message frame has not been specifically defined.

In view of this, a communication method and a communication apparatus for sensing measurement setup termination are provided according to concepts of the embodiments of the present disclosure.

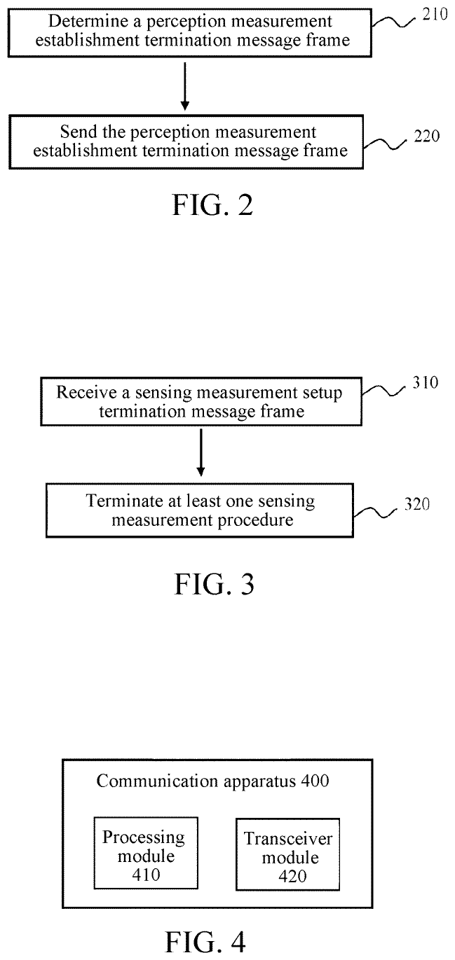

FIG. 2 is a flowchart illustrating a communication method according to an example embodiment. The communication method shown in FIG. 2 may be applied to an access point device (AP), or may also be applied to a station device (STA).

Referring to FIG. 2, in step 210, a sensing measurement setup termination message frame is determined. For example, the sensing measurement setup termination message frame may include information of at least one sensing measurement procedure to be terminated, and the at least one sensing measurement procedure may correspond to at least one sensing measurement setup identifier. For example, the sensing measurement setup identifier (MSID) may be used to identify a sensing measurement procedure. Therefore, the information included in the sensing measurement setup termination message frame may identify that the sensing measurement procedure corresponding to the sensing measurement setup identifier needs to be terminated.

When the sensing measurement setup termination message frame is initiated by the initiator (e.g., AP), the operation of determining the sensing measurement setup termination message frame in step 210 may be performed by the initiator (e.g., AP). When the sensing measurement setup termination message frame is initiated by the responder (e.g., STA), the operation of determining the sensing measurement setup termination message frame in step 210 may be performed by the responder (e.g., STA).

In the embodiments of the present disclosure, there may be many ways to determine the sensing measurement setup termination message frame. For example, the sensing measurement setup termination message frame may be generated or configured according to at least one of the following situations: a WLAN sensing measurement result, a channel status, a network condition, a load condition, a hardware capability of the sending/receiving device, a service type, and a relevant protocol provision, which is not specifically limited by the embodiments of the present disclosure. In the embodiments of the present disclosure, the sensing measurement setup termination message frame may also be obtained from an external device, which is not specifically limited by the embodiments of the present disclosure.

According to the embodiments of the present disclosure, the sensing measurement setup termination message frame may include various information for sensing measurement setup termination.

In step 220, the sensing measurement setup termination message frame is sent. When the sensing measurement setup termination message frame is initiated by the initiator (e.g., AP), the sensing measurement setup termination message frame may be sent by the initiator (e.g., AP) to the responder (e.g., STA). In addition, the initiator (e.g., AP) may send the sensing measurement setup termination message frame to one or more responders (e.g., STAs) to terminate the sensing measurement procedure set up with the one or more STAs. For example, the AP may send the sensing measurement setup termination message frame in the form of multicast or broadcast. However, the present disclosure is not limited thereto. For example, the AP may also send the sensing measurement setup termination message frame in the form of unicast. When the sensing measurement setup termination message frame is initiated by the responder (e.g., STA), the sensing measurement setup termination message frame may be sent by the responder (e.g., STA) to the initiator (e.g., AP). For example, the STA may send the sensing measurement setup termination message frame in a unicast form. However, the present disclosure is not limited thereto.

According to an embodiment of the present disclosure, in a communication method for sensing measurement setup termination, the sensing measurement setup termination message frame may include a first subfield. The first subfield is used to identify the number of the sensing measurement setup identifier (number of MSID). The sensing measurement procedure may correspond to the sensing measurement setup ID, and the first subfield identifies the number of sensing measurement procedures that need to be terminated. Including the “number” information in the sensing measurement setup termination message frame helps the device that receives the sensing measurement setup termination message frame to clearly know the number of the sensing measurement procedures that need to be terminated, and determine whether the number of the sensing measurement procedures that are subsequently terminated is consistent with the “number” information in the first subfield, so as to ensure accurate execution of the termination procedure.

According to an embodiment of the present disclosure, in a communication method for sensing measurement setup termination, the sensing measurement setup termination message frame may include an identification bit used to identify the presence of at least one sensing measurement setup ID (MSID present). For example, when the identification bit is set to a first value (for example, but not limited to “1”), it can identify that there are a plurality of sensing measurement setup IDs in the sensing measurement setup termination message frame, or identify the termination of a plurality of sensing measurement procedures. When the identification bit is set to a second value (for example, but not limited to “0”), it can identify the presence of one sensing measurement setup ID in the sensing measurement setup termination message frame, or identify the termination of one sensing measurement procedure.

According to an embodiment of the present disclosure, in a communication method for sensing measurement setup termination, the sensing measurement setup termination message frame may include at least one sensing measurement setup identifier (MSID). In other words, it may be determined that a specific sensing measurement setup identifier (MSID) is included in the sensing measurement setup termination message frame to identify the termination of the sensing measurement procedure corresponding to the specific MSID.

For example, in the case where the sensing measurement setup termination message frame includes the first subfield, the number of MSIDs included in the sensing measurement setup termination message frame may correspond to (consistent with) the value of the first subfield. However, the present disclosure is not limited thereto. For example, the first subfield may be omitted and at least one MSID may be directly included; or, for example, MSID may not be included but only the first subfield may be included (in this case, in subsequent processes, each sensing measurement procedure may be separately terminated).

For example, in the case where the sensing measurement setup termination message frame includes the MSID presence identification bit (MSID present), based on MSID present being set to the first value, the sensing measurement setup termination message frame may include a plurality of MSIDs; based on MSID present being set to a second value, the sensing measurement setup termination message frame may include one MSID. However, the present disclosure is not limited thereto. For example, the identification bit (MSID present) may be omitted and at least one MSID may be directly included; or, for example, MSID may not be included and only MSID present may be included.

According to an embodiment of the present disclosure, in a communication method for sensing measurement setup termination, the sensing measurement setup termination message frame may include a second subfield, where the second subfield is used to identify a length of the sensing measurement setup termination message frame. Since the sensing measurement setup termination message frame includes a lot of information (for example, it may include at least one MSID and other additional information), including length information in it will help the device that receives the sensing measurement setup termination message frame accurately receive and parse the whole frame.

According to an embodiment of the present disclosure, in a communication method for sensing measurement setup termination, the sensing measurement setup termination message frame may include a measurement setup identifier information field, where the measurement setup identifier information field may include a first subfield and/or a second subfield. The first subfield is used to identify the number of at least one sensing measurement setup identifier corresponding to at least one sensing measurement procedure to be terminated, and the second subfield is used to identify a length of the sensing measurement setup termination message frame. The first subfield and the second subfield have been described in detail in the above embodiments. For the sake of simplicity, repeated descriptions are omitted here.

According to an embodiment of the present disclosure, in a communication method for sensing measurement setup termination, the sensing measurement setup termination message frame may include a measurement setup identifier information field, where the measurement setup identifier information field may include an MSID presence identification bit (MSID present) and/or a second subfield. The MSID presence identification bit is used to identify the presence of at least one sensing measurement setup identifier in the sensing measurement setup termination message frame, and the second subfield is used to identify the length of the sensing measurement setup termination message frame. The MSID presence identification bit and the second subfield have been described in detail in the above embodiments. For the sake of simplicity, repeated descriptions are omitted here.

According to an embodiment of the present disclosure, in a communication method for sensing measurement setup termination, the sensing measurement setup termination message frame may include: a dialog token field (Dialog Token) used to identify the initiation of the sensing measurement setup termination message frame. The value of the dialog token field may be set to the same or different value as in the sensing measurement setup procedure. For example, the value of the dialog token field may be determined (or set) based on the number of MSIDs in the sensing measurement setup termination message frame, the type of the device (AP or STA) sending the sensing measurement setup termination message frame, etc. For example, when the number of the sensing measurement setup identifier is 1 (for example, the first subfield identifies to be 1, the MSID presence identification bit is the second value, or there is only one MSID), and the sensing measurement setup termination message frame is a unicast message frame, the value of the dialog token field may be set to the same or different value as that set in the sensing measurement setup procedure. For example, when the device sending the sensing measurement setup termination message frame is a station device, the number of the sensing measurement setup identifier is at least 1 (for example, the first subfield identifies to be at least 1, the MSID presence identification bit is the first value or the second value, or there is at least one MSID), the sensing measurement setup termination message frame is a unicast message frame, and the value of the dialog token field is set to be the same as or different from the value set during the sensing measurement setup procedure. For example, when the device sending the sensing measurement setup termination message frame is an access point device, the number of the sensing measurement setup identifier is at least 1 (for example, the first subfield identifies to be at least 1, the MSID presence identification bit is the first value or the second value, or there is at least one MSID), and the value of the dialog token field may be set to a value different from the value set during the sensing measurement setup procedure.

The information in the sensing measurement setup termination message frame described in the above embodiments is only exemplary, and the present disclosure is not limited thereto. The sensing measurement setup termination message frame will be described in more detail later with reference to Table 1 and Table 2 below.

As a non-limiting embodiment, the information of at least one sensing measurement procedure to be terminated in the sensing measurement setup termination message frame may be included in an action field of the sensing measurement setup termination message frame. Table 1 and Table 2 below illustrate an exemplary format of the action field of the sensing measurement setup termination message frame in detail.

TABLE 1
Format of the action field of the sensing measurement setup termination message frame

| | | | | | | | |
|---|---|---|---|---|---|---|---|
| Category | Public | Dialog | Measurement | Measurement | MSID1 | MSID2 | . . . |
| | Action | Token | Setup ID | Setup ID | | | |
| | | | Information | Information | | | |
| | | | (number of MSID) | (length) | | | |

TABLE 2
Format of the action field of the sensing
measurement setup termination message frame

| | | | | | | | |
|---|---|---|---|---|---|---|---|
| Category | Public | Dialog | Measurement | Measurement | MSID1 | MSID2 | . . . |
| | Action | Token | Setup ID | Setup ID | | | |
| | | | Information | Information | | | |
| | | | (MSID present) | (length) | | | |

Referring to Table 1, the sensing measurement setup termination message frame may include: a category field (Category), a public action field (Public Action), a dialog token field (Dialog Token), a measurement setup identifier information field (Measurement Setup ID Information), at least one MSID (MSID1, MSID2, etc.) etc. For example, the category field (Category) may identify the protected sensing frame of the sensing measurement setup termination message frame bit (Protected Sensing Frame); the public action field (Public Action) may identify the action taken by the device, for example, in the present disclosure, it identifies the sensing measurement setup termination; the dialog token field (Dialog Token) may identify that the session initiated is for the sensing measurement setup termination message frame; the measurement setup identifier information field (Measurement Setup ID Information) may include information about the MSID, for example, the number of MSID (number of MSID, first subfield) and/or length (length, second subfield); at least one MSID (MSID1, MSID2, etc.) may identify at least one sensing measurement procedure to be terminated.

For example, referring to Table 1, the sensing measurement termination message frame may contain at least one measurement setup identifier (measurement setup ID) information, identifying that the sensing measurement procedure corresponding to the sensing measurement setup ID needs to be terminated. Specifically, in the sensing measurement termination message frame, the sensing measurement setup identifier information field may include: the number of sensing measurement procedures that need to be terminated (number of MSID), which refers to the number of sensing measurement setup identifiers contained in the frame. The later half of the frame may include a specific sensing measurement setup identifier (MSID). In addition, in order to identify the length of the sensing measurement termination message frame, the sensing measurement setup identifier information field may include a subfield length, which is used to identify the length of the entire field containing the measurement setup identifier.

The difference between Table 2 and Table 1 is that the measurement setup identifier information field (Measurement Setup ID Information) in Table 2 may include: MSID presence identification bit (MSID present) and/or length (length, the second subfield).

The measurement setup ID information field (Measurement Setup ID Information) and the first subfield (number of MSID), the second subfield (length) and/or the MSID presence identification bit (MSID present) included therein, and at least one MSID (MSID1, MSID2, etc.) may be similar to the embodiment described above with reference to step 210, and repeated descriptions are omitted here for simplicity.

In addition, the value of the Dialog Token field in Table 1 and Table 2 may be determined (or set) based on the number of MSIDs in the sensing measurement setup termination message frame, the type of device (AP or STA) sending the sensing measurement setup termination message frame, etc.

It will be understood that each element shown in Table 1 and Table 2 exists independently. These elements are exemplarily listed in the same table, but it does not mean that all elements in Table 1 and Table 2 must exist simultaneously according to those shown in Table 1 and Table 2. Therefore, those skilled in the art can understand that the value of each element in Table 1 of the present disclosure is an independent embodiment. In addition, the positions and orders of various fields or subfields shown in Table 1 and Table 2 are only exemplary, and various fields or subfields may be included in different other positions and orders. For example, an element called a “field” may also be used as a “subfield” in other embodiments, and an element called a “subfield” may be used as a “field” in other embodiments. In addition, the elements contained in the sensing measurement setup termination message frame are not limited to Table 1 and Table 2. For example, some elements may be omitted from Table 1 and Table 2, or more other elements may be included in Table 1 and Table 2, or Table 1 and Table 2 may be merged.

The communication method according to the embodiments of the present disclosure improves the mechanism regarding the sensing measurement setup termination. For example, the sensing measurement setup termination message frame is specifically defined, so that one or more sensing measurement procedures can be terminated through one sensing measurement setup termination message frame, thereby saving signaling and reducing power consumption.

Although the above various embodiments and Tables 1 and 2 describe various information included in the sensing measurement setup termination message frame, the present disclosure is not limited thereto, and various deformations and modifications may be made.

According to an embodiment of the present disclosure, a method for sensing measurement setup termination may be applied to an access point device or a station device, and may include: determining and sending a sensing measurement setup termination message frame, where the sensing measurement setup termination message frame may include: the number of sensing measurement setup identifiers (number of MSID). For example, the sensing measurement setup identifier may correspond to the sensing measurement procedure that needs to be terminated, and the number (number of MSID) included in the sensing measurement setup termination message frame may identify the number of sensing measurement procedures that need to be terminated. For example, when the number of sensing measurement setup identifiers (number of MSID) is set to 1, it is identified to terminate one sensing measurement procedure; when the number of sensing measurement setup identifiers (number of MSID) is set to a value greater than 1, it is identified that the number of sensing measurement procedures terminated is the set value.

According to an embodiment of the present disclosure, a method for sensing measurement setup termination may be applied to an access point device or a station device, and may include: determining and sending a sensing measurement setup termination message frame, where the sensing measurement setup termination message frame includes at least one sensing measurement setup identifier (MSID). That is, the sensing measurement setup termination frame may include a specific MSID, and the sensing measurement procedures corresponding to respective MSIDs may be terminated. For example, when the sensing measurement setup termination frame includes a first sensing measurement setup identifier MSID1, it may be identified to terminate the sensing measurement procedure corresponding to MSID1. However, the present disclosure is not limited thereto, and the sensing measurement setup termination frame may also include more MSIDs to terminate more sensing measurement procedures.

According to an embodiment of the present disclosure, a method for sensing measurement setup termination may be applied to an access point device or a station device, and may include: determining and sending a sensing measurement setup termination message frame, where the sensing measurement setup termination message frame may include: the number of sensing measurement setup identifiers (number of MSID), and at least one sensing measurement setup identifier (MSID). For example, the value of number of MSID may correspond to the number of MSIDs included in the sensing measurement setup termination message frame. For example, when the value of number of MSID is 1, the sensing measurement setup termination message frame may include one MSID, and the sensing measurement procedure corresponding to the MSID is terminated. However, the present disclosure is not limited thereto. The value of number of MSID may be set to be greater than 1, and then the number of MSIDs included in the sensing measurement setup termination frame may correspond to the value of number of MSID.

According to an embodiment of the present disclosure, a method for sensing measurement setup termination may be applied to an access point device or a station device, and may include: determining and sending a sensing measurement setup termination message frame, where the measurement setup identifier information field may include length. For example, length may refer to a length of the sensing measurement setup termination message frame. For example, but it is not limited to that length may refer to the number of bits or the number of bytes or the duration of the sensing measurement setup termination message frame.

According to an embodiment of the present disclosure, a method for sensing measurement setup termination may be applied to an access point device or a station device, and may include: determining and sending a sensing measurement setup termination message frame, where the sensing measurement setup termination message frame may include length and at least one sensing measurement setup identifier (MSID), which may be similar to the description of the above embodiments. For the sake of simplicity, repeated description is omitted here.

According to an embodiment of the present disclosure, a method for sensing measurement setup termination may be applied to an access point device or a station device, and may include: determining and sending a sensing measurement setup termination message frame, where the sensing measurement setup termination message frame may include: the number of the sensing measurement setup identifier (number of MSID) and the length (length), which may be similar to the description of the above embodiments. For simplicity, repeated descriptions are omitted here.

According to an embodiment of the present disclosure, a method for sensing measurement setup termination may be applied to an access point device or a station device, and may include: determining and sending a sensing measurement setup termination message frame, where the sensing measurement setup termination message frame includes: the number of sensing measurement setup identifiers (number of MSID), the length (length), and at least one sensing measurement setup identifier (MSID), which may be similar to the description of the above embodiments. For simplicity, repeated descriptions are omitted here.

According to an embodiment of the present disclosure, a method for sensing measurement setup termination may be applied to an access point device or a station device, and may include: determining and sending a sensing measurement setup termination message frame, where the sensing measurement setup termination message frame may include MSID presence identification bit (MSID present). For example, the MSID presence identification bit (MSID present) is used to identify the presence of at least one sensing measurement setup identifier in the sensing measurement setup termination message frame, or to identify the termination of at least one sensing measurement procedure. For example, when the MSID presence identification bit (MSID present) is set to a first value (such as “1”), it can identify the presence of a plurality of MSIDs or termination of a plurality of sensing measurement procedures; when the MSID presence identification bit (MSID present) is set to a second value (for example, “0”), it can identify that there is one MSID or one sensing measurement procedure is terminated.

According to an embodiment of the present disclosure, a method for sensing measurement setup termination may be applied to an access point device or a station device, and may include: determining and sending a sensing measurement setup termination message frame, where the sensing measurement setup termination message frame may include the MSID presence identification bit (MSID present) and the length (length), which may be similar to the description of the above embodiments. For simplicity, repeated descriptions are omitted here.

According to an embodiment of the present disclosure, a method for sensing measurement setup termination may be applied to an access point device or a station device, and may include: determining and sending a sensing measurement setup termination message frame, where the sensing measurement setup termination message frame may include: MSID presence identification bit (MSID present), length (length), and at least one sensing measurement setup identifier (MSID), which may be similar to the description of the above embodiments. For simplicity, repeated descriptions are omitted here.

According to an embodiment of the present disclosure, a method for sensing measurement setup termination may be applied to an access point device or a station device, and may include: determining and sending a sensing measurement setup termination message frame, where the sensing measurement setup termination message frame includes a dialog token field. The value of the dialog token field can identify that the sensing measurement setup termination message frame is initiated. For example, the value of the dialog token field may be set differently based on the number of the sensing measurement procedures that need to be terminated and/or whether the sensing measurement setup termination message frame is a unicast message frame. For example, the number of the sensing measurement setup identifiers may be 1 and the sensing measurement setup termination message frame may be a unicast message frame, and the value of the dialog token field may be determined (or set) to be the same as or different from the value set during the sensing measurement setup procedure. For example, the sensing measurement setup procedure may correspond to the WLAN sensing measurement setup described above with reference to FIG. 1. In this procedure, the value of the dialog token may also be set. The dialog token field in the procedure may identify that the WLAN sensing measurement setup message frame is initiated. Since only one sensing measurement procedure is terminated and the sensing measurement setup termination message frame is a unicast message frame sent to a single device, the value of the dialog token field in the sensing measurement setup termination message frame may be the same as the value in the sensing measurement setup procedure. However, the present disclosure is not limited thereto. In order to distinguish the action of termination from the action of setup, the value of the dialog token field in the sensing measurement setup termination message frame may be set to a value different from the value in the sensing measurement setup procedure.

According to an embodiment of the present disclosure, a method for sensing measurement setup termination may be applied to a station device, and may include: determining and sending a sensing measurement setup termination message frame, where the sensing measurement setup termination message frame may include a dialog token field. The value of the dialog token field can identify that the sensing measurement setup termination message frame is initiated. For example, the value of the dialog token field may be set differently based on the number of sensing measurement procedures that need to be terminated and/or whether the sensing measurement setup termination message frame is a unicast message frame. In the case where the device sending the sensing measurement setup termination message frame is a station device, the sensing measurement setup termination message frame may be a unicast message frame, and the value of the dialog token field may be set to be the same as or different from the value set during the sensing measurement setup procedure. For example, in the case where the communication method of FIG. 2 is executed by the station device (STA), the station device may send the sensing measurement setup termination message frame to the access point device (AP) in the form of a unicast message frame, and the station device may terminate at least one sensing measurement procedure in which it participates. For example, in the case where the station device terminates one sensing measurement procedure, the dialog token field in the sensing measurement setup termination message frame may be set to the same value as in the sensing measurement setup procedure. However, the present disclosure is not limited thereto, and it may be set to different values. For example, in the case where the station device terminates more sensing measurement procedures, the dialog token field in the sensing measurement setup termination message frame may be a newly set value, that is, set to a value different from that in the sensing measurement setup procedure.

According to an embodiment of the present disclosure, a method for sensing measurement setup termination may be applied to an access point device, and may include: determining and sending a sensing measurement setup termination message frame, where the sensing measurement setup termination message frame may include a dialog token field. The value of the dialog token field can identify that the sensing measurement setup termination message frame is initiated. For example, the value of the dialog token field may be set differently based on the number of sensing measurement procedures that need to be terminated and/or whether the sensing measurement setup termination message frame is a multicast or broadcast message frame. When the device sending the sensing measurement setup termination message frame is an access point device, the number of sensing measurement setup identifiers is at least 1 and the sensing measurement setup termination message frame is a multicast or broadcast message frame, then the value of the dialog token field can be set to a different value than the value set in the sensing measurement setup procedure. For example, the access point device (AP) may send a sensing measurement setup termination message frame to a plurality of station devices (receivers) to initiate a sensing measurement procedure set up with a plurality of station devices. For example, the access point device (AP) may send the sensing measurement setup termination message frame in a multicast or broadcast manner, and the value of the dialog token field in the sensing measurement setup termination message frame can be a newly set value (that is, different from the value set during the sensing measurement setup procedure). In this case, optionally, the sensing measurement setup termination message frame may also include a receiver address (RA), where the receiver address may be a multicast address or a broadcast address, which is used to identify that the access point device initiates the termination of the sensing measurement procedures set up with a plurality of receivers.

According to an embodiment of the present disclosure, a method for sensing measurement setup termination may be applied to an access point device or a station device, and may include: determining and sending a sensing measurement setup termination message frame, where the sensing measurement setup termination message frame may include a receiver address. The receiver address is used to identify the address (such as, but not limited to, MAC address) of the device (i.e., the receiver) that receives the sensing measurement setup termination message frame. Including the receiver address in the sensing measurement setup termination message frame may identify the termination of the sensing measurement procedure set up with the receiver corresponding to the receiver address.

According to an embodiment of the present disclosure, a method for sensing measurement setup termination may be applied to an access point device, and may include: determining and sending a sensing measurement setup termination message frame, where the sensing measurement setup termination message frame may include a receiver address (RA), and RA may be a multicast address or a broadcast address. When the RA is a multicast address or a broadcast address, the sensing measurement setup termination message frame may be sent to a plurality of station devices (a plurality of receivers), and is used to identify the access point device to terminate the sensing measurement procedures set up with a plurality of receivers.

The communication method according to the embodiments of the present disclosure improves the mechanism regarding the sensing measurement setup termination. For example, the sensing measurement setup termination message frame is specifically defined, so that one or more sensing measurement procedures can be terminated through one sensing measurement setup termination message frame, thereby saving signaling and reducing power consumption.

FIG. 3 is a flowchart illustrating another communication method according to an example embodiment. The communication method shown in FIG. 3 can be applied to a station device (STA), or can also be applied to an access point device (AP). For example, when the communication method of FIG. 2 is executed by the AP, the communication method of FIG. 3 may be executed by the STA; when the communication method of FIG. 2 is executed by the STA, the communication method of FIG. 3 may be executed by the AP.

Referring to FIG. 3, in step 310, a sensing measurement setup termination message frame may be received, where the sensing measurement setup termination message frame may include information of at least one sensing measurement procedure to be terminated, where the at least one sensing measurement procedure may correspond to at least one sensing measurement setup identifier.

In step 320, at least one sensing measurement procedure may be terminated according to the sensing measurement setup termination message frame.

According to an embodiment of the present disclosure, the sensing measurement setup termination message frame may include: a first subfield used to identify the number of the sensing measurement setup identifiers, such as “number of MSID” in Table 1.

According to an embodiment of the present disclosure, the sensing measurement setup termination message frame may include: at least one sensing measurement setup identifier, such as “MSID1, MSID2, etc.” in Table 1 and Table 2.

According to an embodiment of the present disclosure, the information in the sensing measurement setup termination message frame may include: a second subfield used to identify the length of the sensing measurement setup termination message frame, such as “length” in Table 1 and Table 2.

According to an embodiment of the present disclosure, the sensing measurement setup termination message frame may include: an identification bit used to identify the presence of at least one sensing measurement setup identifier, such as “MSID present” in Table 2.

According to an embodiment of the present disclosure, the sensing measurement setup termination message frame may include a measurement setup identifier information field (such as “Measurement Setup ID Information” in Table 1 and Table 2), where the first subfield, the second subfield, and/or the identification bit (MSID present) may be included in the measurement setup identifier information field.

According to an embodiment of the present disclosure, the sensing measurement setup termination message frame may include: a dialog token field used to identify the initiation of the sensing measurement setup termination message frame, such as “Dialog Token” in Table 1 and Table 2.

According to an embodiment of the present disclosure, when the number of the sensing measurement setup identifier is 1 and the sensing measurement setup termination message frame is a unicast message frame, the value of the dialog token field may be set to be the same as or different from the value set in the sensing measurement setup procedure.

According to an embodiment of the present disclosure, in the case where a sensing measurement setup termination message frame is received from a station device, the number of the sensing measurement setup identifiers is at least 1, the sensing measurement setup termination message frame is a unicast message frame, and the value of the dialog token field is set to be the same as or different from the value in the sensing measurement setup procedure.

According to an embodiment of the present disclosure, in the case where the sensing measurement setup termination message frame is received from the access point device, the number of the sensing measurement setup identifiers is at least 1, and the value of the dialog token field is set to be different from the value in the sensing measurement setup procedure.

According to an embodiment of the present disclosure, the sensing measurement setup termination message frame may also include a receiver address, where the receiver address is a multicast address or a broadcast address, and is used to identify that the access point device initiates the termination of the sensing measurement procedures set up with a plurality of receivers.

Specific descriptions of the sensing measurement setup termination message frame, the first subfield, the sensing measurement setup identifier, the second subfield, the dialog token field, etc. have been described in detail in the foregoing embodiments and will not be repeated here.

The embodiments of the present disclosure clearly define the sensing measurement setup termination message frame to improve the mechanism of sensing measurement setup termination.

Although the information contained in the sensing measurement setup termination message frame is described above with reference to various embodiments, these are only descriptive embodiments and are not limitations of the present disclosure. Various variations and modifications may be made to the various embodiments.

The embodiments of the present disclosure may provide a communication method for sensing measurement setup termination, the communication method may be applied to an access point device or a station device, and the communication method may include: receiving a sensing measurement setup termination message frame, where the sensing measurement setup termination message frame may include the number of sensing measurement setup identifiers (number of MSID). The above descriptions about number of MSID in various embodiments may be quoted here. For the sake of simplicity, repeated descriptions are omitted here.

The embodiments of the present disclosure may provide a communication method for sensing measurement setup termination, the communication method may be applied to an access point device or a station device, and the communication method may include: receiving a sensing measurement setup termination message frame, where the sensing measurement setup termination message frame may include: at least one sensing measurement setup identifier (MSID) corresponding to at least one sensing measurement procedure to be terminated. The above descriptions about MSID in various embodiments may be quoted here. For the sake of simplicity, repeated descriptions are omitted here.

The embodiments of the present disclosure may provide a communication method for sensing measurement setup termination, the communication method may be applied to an access point device or a station device, and the communication method may include: receiving a sensing measurement setup termination message frame, where the sensing measurement setup termination message frame may include length, which refers to the length of the sensing measurement setup termination message frame. The above descriptions about length in various embodiments may be quoted here. For the sake of simplicity, repeated descriptions are omitted here.

The embodiments of the present disclosure may provide a communication method for sensing measurement setup termination, the communication method may be applied to an access point device or a station device, and the communication method may include: receiving a sensing measurement setup termination message frame, where the sensing measurement setup termination message frame may include the MSID presence identification bit (MSID present). The above descriptions about MSID present in various embodiments may be quoted here. For the sake of simplicity, repeated descriptions are omitted here.

The embodiments of the present disclosure may provide a communication method for sensing measurement setup termination, the communication method may be applied to an access point device or a station device, and the communication method may include: receiving a sensing measurement setup termination message frame, where the sensing measurement setup termination message frame may include the number of sensing measurement setup identifiers (number of MSID) and the length (length), or the sensing measurement setup termination message frame may include the MSID presence identification bit (MSID present) and the length (length). The above descriptions about number of MSID, MSID present, and length (length) in various embodiments may be quoted here. For the sake of simplicity, repeated descriptions are omitted here.

The embodiments of the present disclosure may provide a communication method for sensing measurement setup termination, the communication method may be applied to an access point device or a station device, and the communication method may include: receiving a sensing measurement setup termination message frame, where the sensing measurement setup termination message frame may include a dialog token field used to identify the initiation of the sensing measurement setup termination message frame. The value of the dialog token field may be set to be the same as or different from the value in the sensing measurement setup procedure. The above descriptions about the dialog token field in various embodiments may be quoted here. For the sake of simplicity, repeated descriptions are omitted here.

The embodiments of the present disclosure may provide a communication method for sensing measurement setup termination, which may be applied to an access point device or a station device, and the method may include: receiving a sensing measurement setup termination message frame, where the sensing measurement setup termination message frame may include a receiver address for identifying the termination of the sensing measurement procedure set up with the receiver corresponding to the receiver address.

The embodiments of the present disclosure may provide a communication method for sensing measurement setup termination, which may be applied to a station device, and the method may include: receiving a sensing measurement setup termination message frame from an access point device, where the sensing measurement setup termination message frame may include a receiver address, the receiver address is a multicast address or a broadcast address, and is used to identify the access point device to initiate the termination of the sensing measurement procedure set up with a plurality of receivers.

FIG. 4 is a block diagram illustrating a communication apparatus according to an example embodiment. The communication apparatus 400 of FIG. 4 may include a processing module 410 and a transceiver module 420. In one embodiment of the present disclosure, the communication apparatus 400 shown in FIG. 4 may be applied to an initiating device or a responding device of the sensing measurement setup termination. For example, the initiating device may be an AP and the responding device may be a STA, or the initiating device may be an STA and the responding device may be an AP.

For example, in the case where the communication apparatus 400 shown in FIG. 4 is applied to an initiating device of the sensing measurement setup termination, the processing module 410 may be configured to: determine a sensing measurement setup termination message frame, where the sensing measurement setup termination message frame includes information of at least one sensing measurement procedure to be terminated, where the at least one sensing measurement procedure corresponds to at least one sensing measurement setup identifier; the transceiver module 420 may be configured to: send the sensing measurement setup termination message frame. That is, the communication apparatus 400 shown in FIG. 4 can perform the communication method described with reference to FIG. 2, and the various modified embodiments above and the embodiments described with reference to Table 1 and Table 2 can be applied thereto. In order to avoid redundancy, repeated descriptions are omitted here.

The communication apparatus 400 shown in FIG. 4 may be applied to a responding device of the sensing measurement setup termination. In this case, the transceiver module 420 may be configured to receive a sensing measurement setup termination message frame, where the sensing measurement setup termination message frame includes information about at least one sensing measurement procedure to be terminated, where at least one sensing measurement procedure corresponds to at least one sensing measurement setup identifier; the processing module 410 may be configured to terminate at least one sensing measurement procedure according to the sensing measurement setup termination message frame. That is, the communication apparatus 400 shown in FIG. 4 can execute the communication method described with reference to FIG. 3, and the various modified embodiments mentioned above and the embodiments described with reference to Tables 1 and 2 can be applied thereto. To avoid redundancy, repeated descriptions are omitted here.

It will be understood that the communication apparatus 400 shown in FIG. 4 is only exemplary, and the embodiments of the present disclosure are not limited thereto. For example, the communication apparatus 400 may also include other modules, such as a memory module and the like. Furthermore, individual modules in the communication apparatus 400 may be combined into more complex modules, or may be divided into more separate modules.

The communication method and communication apparatus according to the embodiments of the present disclosure clearly define the sensing measurement setup termination message frame to improve the mechanism of sensing measurement setup termination.

Based on the same principles as the methods provided by the embodiments of the present disclosure, the embodiments of the present disclosure also provide an electronic apparatus. The electronic apparatus includes a processor and a memory; where the memory stores machine-readable instructions (also may be referred to as a “computer program”); a processor for executing the machine-readable instructions to implement the methods described with reference to FIGS. 2 and 3.

The embodiments of the present disclosure also provide a computer-readable storage medium, and a computer program is stored on the computer-readable storage medium. When the computer program is executed by a processor, the methods described with reference to FIG. 2 and FIG. 3 are implemented.

In an example embodiment, the processor may be used to implement or execute various exemplary logical blocks, modules and circuits described in conjunction with the present disclosure, such as a Central Processing Unit (CPU), a general-purpose processing unit, a Digital Signal Processor (DSP), an Application Specific Integrated Circuit (ASIC), a Field Programmable Gate Array (FPGA) or other programmable logic devices, transistor logic devices, hardware components or any combination thereof. The processor may also be a combination that implements computing functions, such as a combination containing one or more microprocessors, a combination of a DSP and a microprocessor, etc.

In an example embodiment, the memory may be, for example, a Read Only Memory (ROM), a Random Access Memory (RAM), an Electrically Erasable Programmable Read Only Memory (EEPROM), a Compact Disc Read Only Memory (CD-ROM), or other optical disk storage, optical disc storage (including compressed optical discs, laser discs, optical discs, digital versatile discs, Blu-ray discs, etc.), magnetic disk storage media or other magnetic storage device, or any other medium that can be used to carry or store the program code in the form of instructions or data structures that can be accessed by a computer, but is not limited thereto.

It should be understood that although various steps in the flowchart of the accompanying drawings are shown in sequence as indicated by arrows, these steps are not necessarily performed in the order indicated by the arrows. Unless explicitly stated in the present disclosure, the execution of these steps is not strictly limited in order, and they can be executed in other orders. In addition, at least some of the steps in the flowchart of the accompanying drawings may include multiple sub-steps or multiple stages. These sub-steps or stages are not necessarily executed at the same time, but may be executed at different times, and their execution order does not necessarily need to be performed sequentially, but may be performed in turn or alternately with other steps or sub-steps of other steps or at least part of the stages.

Although the present disclosure has been shown and described with reference to certain embodiments thereof, those skilled in the art will understand that various changes may be made in form and detail without departing from the scope of the present disclosure. Therefore, the scope of the present disclosure should not be limited to the embodiments, but should be defined by the appended claims and their equivalents.

1. A communication method for sensing measurement setup termination, comprising:
determining a sensing measurement setup termination message frame, wherein the sensing measurement setup termination message frame comprises information of at least one sensing measurement procedure to be terminated, wherein the at least one sensing measurement procedure corresponds to at least one sensing measurement setup identifier; and
sending the sensing measurement setup termination message frame.

2. The communication method according to claim 1, wherein the sensing measurement setup termination message frame comprises at least one of:
the at least one sensing measurement setup identifier;
a first subfield configured to identify a number of the at least one sensing measurement setup identifier;
an identification bit configured to identify a presence of the at least one sensing measurement setup identifier; or
a second subfield configured to identify a length of the sensing measurement setup termination message frame.

3.-5. (canceled)

6. The communication method according to claim 2, wherein the sensing measurement setup termination message frame comprises at least one of:
a measurement setup identifier information field; or
a dialog token field configured to identify initiating the sensing measurement setup termination message frame;
wherein at least one of the first subfield, the second subfield, or the identification bit is comprised in the measurement setup identifier information field.

7. (canceled)

8. The communication method according to claim 6, wherein in response to a number of the at least one sensing measurement setup identifier being 1 and the sensing measurement setup termination message frame being a unicast message frame, a value of the dialog token field is set to the same as or different from a value set in a sensing measurement setup procedure.

9. The communication method according to claim 6, wherein:
in response to a device sending the sensing measurement setup termination message frame being a station, a number of the at least one sensing measurement setup identifier is at least 1, the sensing measurement setup termination message frame is a unicast message frame, and a value of the dialog token field is set to the same as or different from a value set in a sensing measurement setup procedure; or
in response to a device sending the sensing measurement setup termination message frame being an access point, a number of the at least one sensing measurement setup identifier is at least 1, and a value of the dialog token field is set to different from a value set in a sensing measurement setup procedure.

10. (canceled)

11. The communication method according to claim 9, wherein the sensing measurement setup termination message frame further comprises a receiver address,
wherein the receiver address is a multicast address or a broadcast address, which is configured to identify the access point to initiate a termination of sensing measurement procedures set up with a plurality of receivers.

12. A communication method for sensing measurement setup termination, comprising:
receiving a sensing measurement setup termination message frame, wherein the sensing measurement setup termination message frame comprises information of at least one sensing measurement procedure to be terminated, wherein the at least one sensing measurement procedure corresponds to at least one sensing measurement setup identifier; and
terminating the at least one sensing measurement procedure according to the sensing measurement setup termination message frame.

13. The communication method according to claim 12, wherein the sensing measurement setup termination message frame comprises at least one of:
the at least one sensing measurement setup identifier;
a first subfield configured to identify a number of the at least one sensing measurement setup identifier;
an identification bit configured to identify a presence of the at least one sensing measurement setup identifier; or
a second subfield configured to identify a length of the sensing measurement setup termination message frame.

14.-16. (canceled)

17. The communication method according to claim 13, wherein the sensing measurement setup termination message frame comprises at least one of:
a measurement setup identifier information field; or
a dialog token field configured to identify to initiate the sensing measurement setup termination message frame;
wherein at least one of the first subfield, the second subfield, or the identification bit is comprised in the measurement setup identifier information field.

18. (canceled)

19. The communication method according to claim 17, wherein in response to a number of the at least one sensing measurement setup identifier being 1 and the sensing measurement setup termination message frame being a unicast message frame, a value of the dialog token field is set to the same as or different from a value set in a sensing measurement setup procedure.

20. The communication method according to claim 17, wherein:
in response to the sensing measurement setup termination message frame being received from a station, a number of the at least one sensing measurement setup identifier is at least 1, the sensing measurement setup termination message frame is a unicast message frame, and a value of the dialog token field is set to the same as or different from a value in a sensing measurement setup procedure; or
in response to the sensing measurement setup termination message frame being received from an access point, a number of the at least one sensing measurement setup identifier is at least 1, and a value of the dialog token field is set to different from a value in a sensing measurement setup procedure.

21. (canceled)

22. The communication method according to claim 20, wherein the sensing measurement setup termination message frame further comprises a receiver address,
wherein the receiver address is a multicast address or a broadcast address, which is configured to identify the access point to initiate a termination of sensing measurement procedures set up with a plurality of receivers.

23. A communication apparatus, comprising:
a processor; and
a memory storing instructions executable by the processor;
wherein in the processor is configured to:
determine a sensing measurement setup termination message frame, wherein the sensing measurement setup termination message frame comprises information of at least one sensing measurement procedure to be terminated, wherein the at least one sensing measurement procedure corresponds to at least one sensing measurement setup identifier; and
send the sensing measurement setup termination message frame.

24. A communication apparatus, comprising:
a processor; and
a memory storing instructions executable by the processor;
wherein in the processor is configured to perform the communication method according to claim 12.

25. (canceled)

26. (canceled)

27. The communication apparatus according to claim 23, wherein the sensing measurement setup termination message frame comprises at least one of:
the at least one sensing measurement setup identifier;
a first subfield configured to identify a number of the at least one sensing measurement setup identifier;
an identification bit configured to identify a presence of the at least one sensing measurement setup identifier; or
a second subfield configured to identify a length of the sensing measurement setup termination message frame.

28. The communication apparatus according to claim 27, wherein the sensing measurement setup termination message frame comprises at least one of:
a measurement setup identifier information field; or
a dialog token field configured to identify initiating the sensing measurement setup termination message frame;
wherein at least one of the first subfield, the second subfield, or the identification bit is comprised in the measurement setup identifier information field.

29. The communication apparatus according to claim 28, wherein in response to a number of the at least one sensing measurement setup identifier being 1 and the sensing measurement setup termination message frame being a unicast message frame, a value of the dialog token field is set to the same as or different from a value set in a sensing measurement setup procedure.

30. The communication apparatus according to claim 28, wherein:
in response to a device sending the sensing measurement setup termination message frame being a station, a number of the at least one sensing measurement setup identifier is at least 1, the sensing measurement setup termination message frame is a unicast message frame, and a value of the dialog token field is set to the same as or different from a value set in a sensing measurement setup procedure; or
in response to a device sending the sensing measurement setup termination message frame being an access point, a number of the at least one sensing measurement setup identifier is at least 1, and a value of the dialog token field is set to different from a value set in a sensing measurement setup procedure.

31. The communication apparatus according to claim 30, wherein the sensing measurement setup termination message frame further comprises a receiver address,
wherein the receiver address is a multicast address or a broadcast address, which is configured to identify the access point to initiate a termination of sensing measurement procedures set up with a plurality of receivers.
